(19) United States
(12) Patent Application Publication
(10) Pub. No.: US 2013/0054223 A1
(43) Pub. Date: Feb. 28, 2013

(54) INFORMATION PROCESSING DEVICE, INFORMATION PROCESSING METHOD, AND COMPUTER READABLE STORAGE MEDIUM

(71) Applicant: Kouji Fusano, Saitama (JP)

(72) Inventor: Kouji Fusano, Saitama (JP)

(73) Assignee: CASIO COMPUTER CO., LTD., Tokyo (JP)

(21) Appl. No.: 13/569,439

(22) Filed: Aug. 8, 2012

(30) Foreign Application Priority Data
Aug. 24, 2011 (JP) 2011-182668

(51) Int. Cl. G06F 17/28

(52) U.S. Cl. 704/2

(57) ABSTRACT

An information processing device of the present invention includes: an acquisition unit that acquires an attribute of a target person accepting information; a language conversion unit that determines the target person based on the attribute acquired by way of the acquisition unit, and converts a language of an output target to a language corresponding to the target person; and an output control unit that outputs information in the language thus converted by way of the language conversion unit.

This application is based on and claims the benefit of priority from Japanese Patent Application No. 2011-182668, filed on 24 Aug. 2011, the content of which is incorporated herein by reference.

### BACKGROUND OF THE INVENTION

1. Field of the Invention

The present invention relates to an information processing device, information processing method, and a computer readable storage medium.

2. Related Art

The order entry systems that have been used in shops serving food and drink such as restaurants, when an employee in the hall receives the order of a customer with an order input terminal, an order slip corresponding to the order is outputted from a printer of the kitchen, and an employee in the kitchen starts food preparation, looking at the order slip. However, the number of foreign employees has been increasing in recent years, and there has come to be not only employees with the working language of the shop serving food and drink (e.g., Japanese employees in a Japanese shop serving food and drink) in the kitchen, and a mixture of employees with different languages from the working language as their native languages (e.g., Chinese employees and Korean employees in a Japanese shop serving food and drink) are present. As a result, it has been considered to both list menu names according to Japanese writing and menu names according to Latin alphabet writing with a conventional order entry system (e.g., refer to Japanese Unexamined Patent Application, Publication No. 2010-211630).

### SUMMARY OF THE INVENTION

However, there has been the inconvenience of not being able to handle a case of an employee with another language as their native language being present in the kitchen by only fixed language writing such as Japanese writing and Latin alphabet writing.

The object of the present invention is to be able to output information in the language corresponding to the working language of a target person.

According to the present invention, an information processing device includes: an acquisition unit that acquires an attribute of a target person accepting information; a language conversion unit that determines the target person based on the attribute acquired by way of the acquisition unit, and converts a language of an output target to a language corresponding to the target person; and an output control unit that outputs information in the language thus converted by way of the language conversion unit.

According to computer readable recording medium of the present invention, the non-transitory computer readable medium records a program for causing a computer to execute the following sequence, in which the sequence includes: acquiring an attribute of a target person accepting information; determining the target person based on the attribute thus acquired, and converting a language of an output target to a language corresponding to the target person; and outputting information in the language thus converted.

According to the present invention, information can be outputted in a language corresponding to the working language of a target person.

### BRIEF DESCRIPTION OF THE DRAWINGS

FIG. 1 shows the configuration of an information processing system according to an embodiment of the present invention;

FIG. 2 is a table illustrating an example of clock in/out information stored in the ECR of FIG. 1;

FIG. 3 is a table illustrating an example of language attributes stored in the ECR of FIG. 1;

FIG. 4 is a table illustrating an example of work attributes stored in the ECR of FIG. 1;

FIG. 5 is a table illustrating an example of deployment attributes stored in the controller box of FIG. 1;

FIG. 6 is a block diagram showing the configuration of hardware of the ECR of FIG. 1;

FIG. 7 is a block diagram showing the configuration of hardware of the controller box of FIG. 1;

FIG. 8 is a functional block diagram showing, among the functional configurations of the information processing system of FIG. 1, the functional configuration for executing clock-in processing, clock-out processing, language information conversion processing and order information output processing;

FIG. 9 is a table illustrating an example of the statuses stored at each position of target persons, in the information file stored in the language attribute storage unit of FIG. 8;

FIG. 10 is a table illustrating an example of language attributes in the information file stored in the language attribute storage unit of FIG. 8;

FIG. 11 is a flowchart illustrating a flow sequence of clock-in processing executed by the ECR of FIG. 1;

FIG. 12 is a flowchart illustrating a flow sequence of clock-out processing executed by the ECR of FIG. 1;

FIG. 13 is a flowchart illustrating a flow sequence of language information conversion processing executed by the controller box of FIG. 1;

FIG. 14 is a flowchart illustrating a flow sequence of order information output processing executed by the controller box of FIG. 1;

FIG. 15 shows an example of an order slip output by the printer of FIG. 1; and

FIG. 16 shows the configuration of an information processing system according to an embodiment of the present invention differing from the embodiment of FIG. 1.

### DETAILED DESCRIPTION OF THE INVENTION

Hereinafter, embodiments of the present invention will be explained while referencing the drawings.

### Configuration of Information Processing System

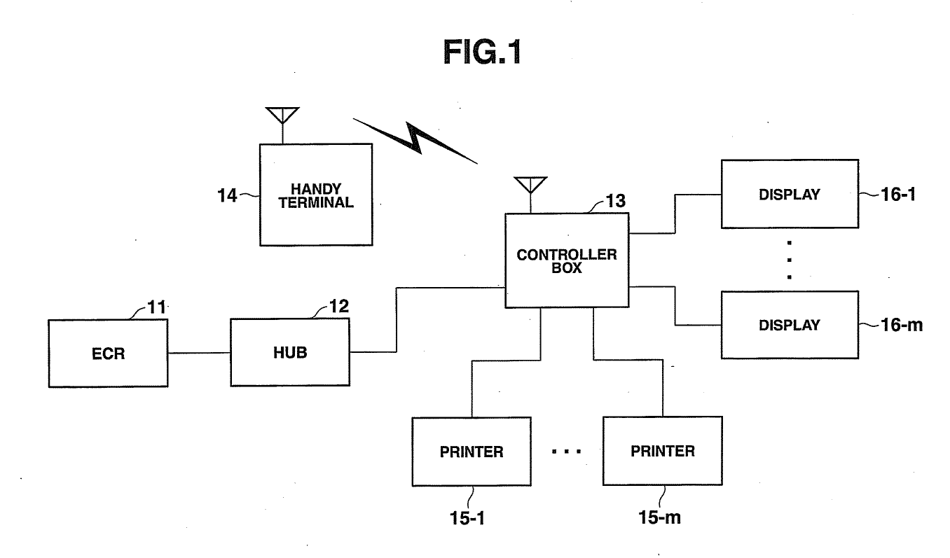

FIG. 1 shows the configuration of an information processing system according to an embodiment of the present invention.

The information processing system according to the present embodiment is an order entry system that is arranged in the retail area of a shop serving food and drink, and executes a sequence of control until outputting order information of cuisine accepted at a guest seat as an order slip at a printer or display arranged in the kitchen.

As shown in FIG. 1, the information processing system according to the present embodiment includes an ECR (Electronic Cash Register) 11, HUB 12, controller box 13, handy terminal 14, printers 15-1 to 15-m, and displays 16-1 to 16-m. Herein, “m” is any integer of 1 or greater, and in the present embodiment, is a value equal to the number of cooking areas in the kitchen.

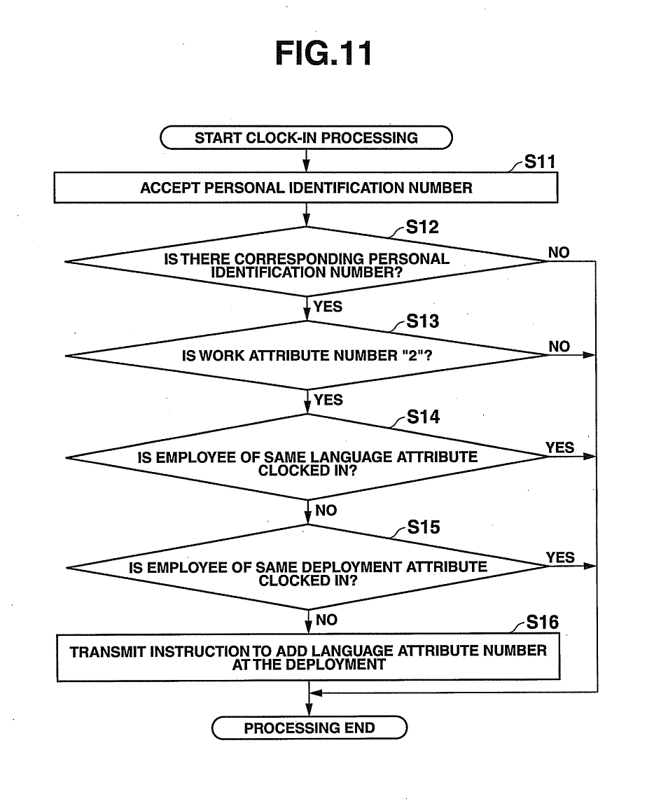

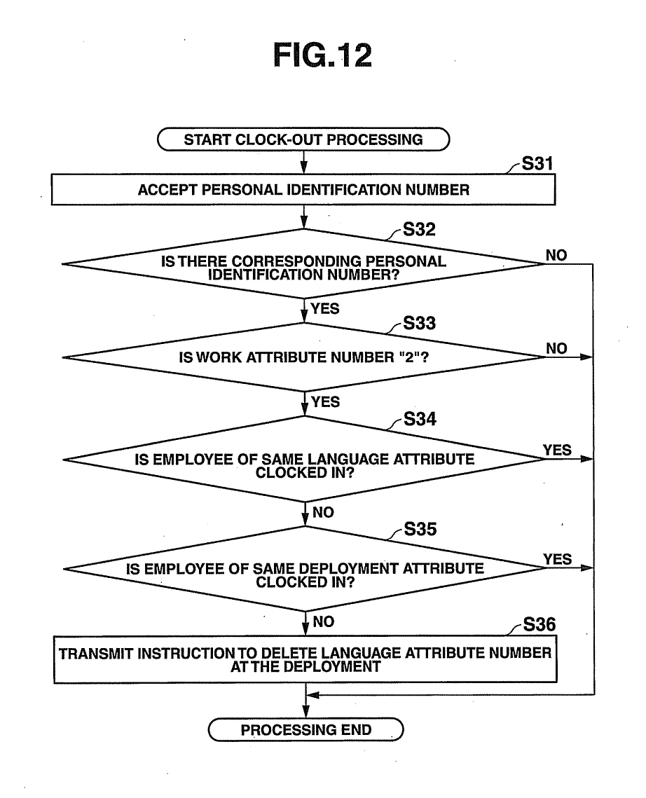

The ECR 11 is established at a location at which the bill is paid inside the retail area, is operated by a user that is the owner of the shop or an employee of the shop, and normally has a function of a so-called register. In addition, the ECR 11 also has a function of a so-called time recorder, accepts clock-in information of employees and transmits to the controller box 13 during the clock-in processing shown in FIG. 11 described later, and accepts clock-in information of employees and transmits to the controller box 13 during the clock-out processing of FIG. 12 described later.

The ECR 11 connects together with the controller box 13 by way of a LAN (Local Area Network) line (not illustrated) via the HUB 12.

In addition to connecting with the ECR 11 via the HUB 12 as described above, the controller box 13 also connects with the handy terminal 14, printers 15-1 to 15-m, and displays 16-1 to 16-m.

In the present embodiment, “m” number of cooking areas (“m” being an integer of at least 1) exist in the kitchen, and a printer 15-k and display 16-k are arranged at the k^{th} cooking area (“k” being an integer in the range of 1 to “m”).

Hereinafter, it should be noted that, in the case of it not being necessary to individually distinguish between the printers 15-1 to 15-m, these will collectively be referred to simply as “printer 15”. Similarly, hereinafter, in a case of it not being necessary to individually distinguish between the displays 16-1 to 16-m, these will collectively be referred to simply as “display 16”.

The handy terminal 14 is carried by the employees of the shop, and when an operation to accept an order for cuisine is made by the employee, wirelessly transmits order information thereof to the controller box 13.

When this order information is received, the controller box 13 executes control to output this order information as an order slip at the printer 15 and display 16.

More specifically, the controller box 13 acquires, from the ECR 11 via the HUB 12, the clock in/out information of a plurality of target persons for which the language of accepted information has been set in advance.

Herein, a “target person” in the present embodiment is an employee making cuisine in the kitchen, and “accepted information” by the target person is an order slip specified according to the order information (order slip on which the information of the cuisine to be made is written). In other words, the language of the accepted information is the language written on the order slip, and is set in advance for every employee. For example, in a case of a first employee being Japanese, the Japanese language is set in advance as the language of accepted information. In addition, in a case of a second employee being Chinese, for example, the Chinese language is set in advance as the language of accepted information.

Next, the controller box 13 determines a clocked-in target person based on the clock in/out information previously acquired, and converts the language of an output target to the language set for the clocked-in target person. More specifically, if the first employee is clocked in, the language of the output target will be converted to the Japanese language. If the second employee is clocked in, the language of the output target will be converted to the Chinese language.

It should be noted that in the case of both the first employee and the second employee being clocked in, the language of the output target will be converted to the Japanese language and the Chinese language. In other words, the language of the output target is not particularly limited to one type, and can be a plurality of types.

Then, the controller box 13 generates an order slip in the language(s) that has/have been converted as the output target, and outputs this order slip to the printer 15 and display 16.

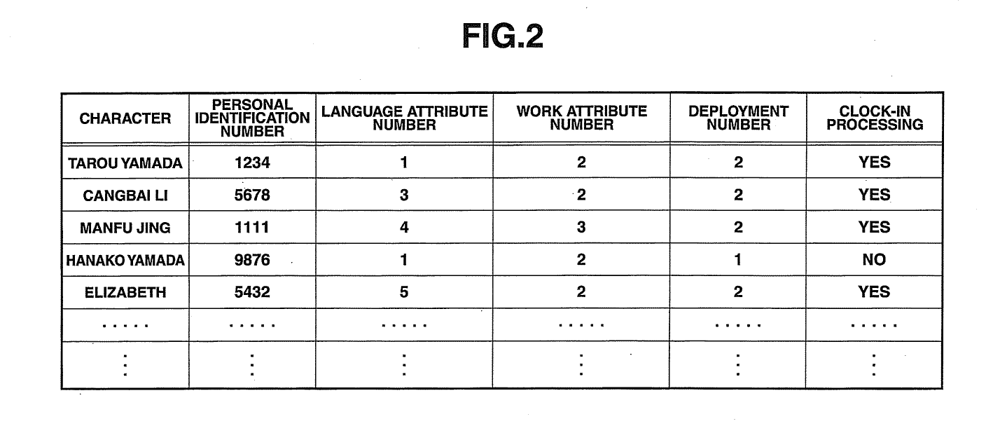

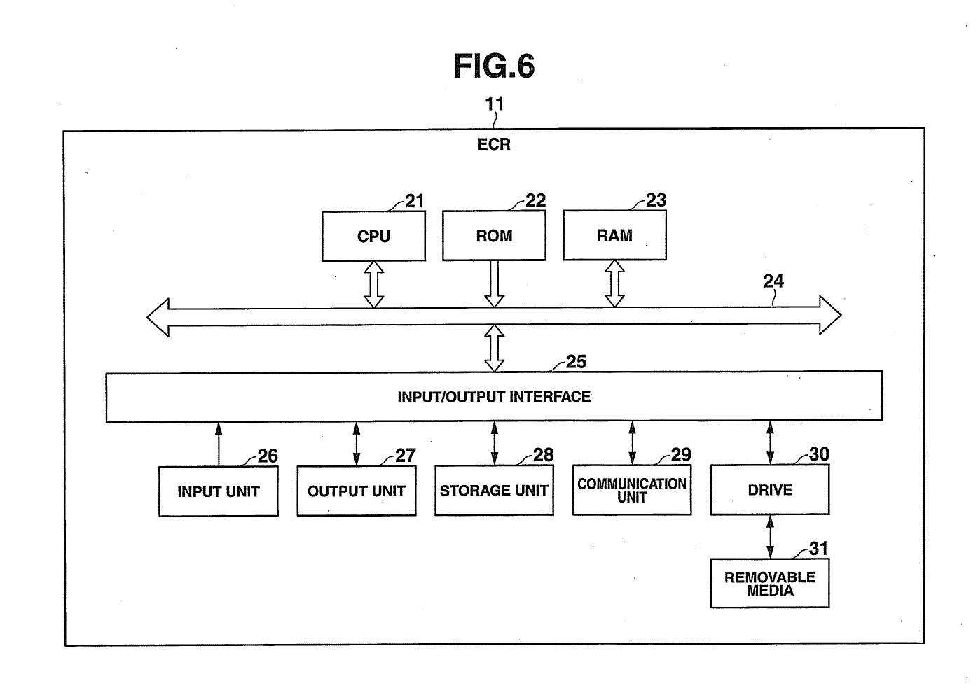

As the information required in realizing the above processing by the controller box 13, the information stored in the ECR 11 is shown in FIGS. 2 to 5, and the information stored in the controller box 13 is shown in FIG. 6.

FIG. 2 is a table illustrating an example of clock in/out information stored in the ECR 11. The clock in/out information stored in the ECR 11 includes “character”, “personal identification number”, “language attribute number”, “work attribute number”, “deployment”, and “clocked in”. Therefore, it is sufficient if the structure of the clock in/out information stored in the ECR 11 shows such a relationship, and is not particularly limited; however, in the present embodiment, it is made in a matrix structure as shown in FIG. 2.

More specifically, “character” saved in a predetermined column is information indicating the full name for identifying each employee, and is information indicating the full name for identifying each employee when carrying out the clock-in processing or clock-out processing described later. In addition, “personal identification number” saved in a predetermined column is a number for determining whether an employee is the proper person when performing the clock-in processing or clock-out processing described later. Moreover, “language attribute number” saved in a predetermined column is information indicating a language attribute for identifying the working language used by an employee working in the shop serving food and drink. Furthermore, “work attribute number” saved in a predetermined column is information indicating a work attribute for identifying the occupation of an employee working in the shop serving food and drink.

Moreover, “deployment number” saved in a predetermined column is information indicating a station of an employee present in the shop serving food and drink (in-house, particularly in the kitchen). Additionally, “clocked-in information” saved in a predetermined column is information indicating the clocked-in state for identifying whether an employee working in the restaurant is currently clocked in at the shop serving food and drink.

Furthermore, although the clock in/out information of FIG. 2 is stored in the ECR 11 in the present embodiment, it is not limited thereto, and may be in another device such as the controller box 13.

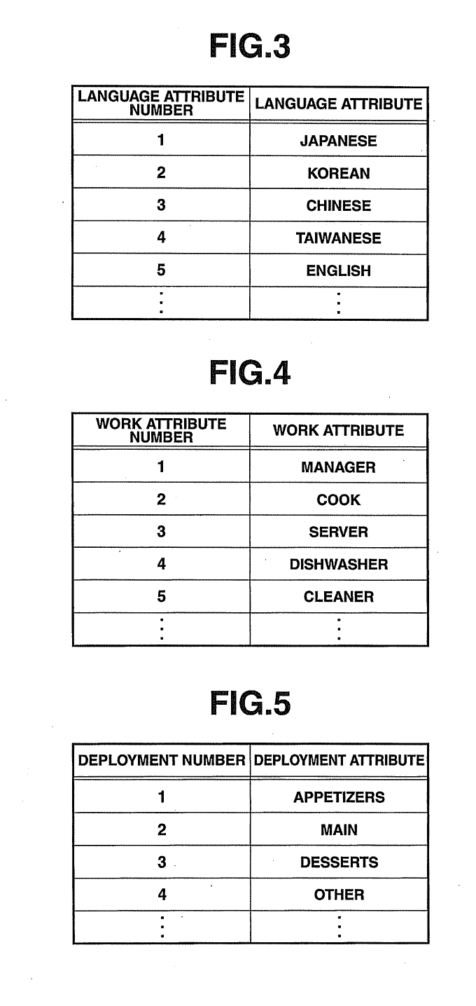

FIG. 3 is a table illustrating an example of language attributes stored in the ECR 11. The language attributes stored in the ECR 11 include information of the language corresponding to every language attribute number. Therefore, it is sufficient if the structure of language attributes stored in the ECR 11 show such a relationship, and is not particularly limited; however, in the present embodiment, it is made in a matrix structure as shown in FIG. 3.

More specifically, the language attribute of “Japanese language” corresponding to the language attribute number “1” is stored. In addition, the language attribute of “Korean language” corresponding to the language attribute number “2” is stored. Furthermore, the language attribute of “Chinese language” corresponding to the language attribute number “3” is stored. Additionally, the language attribute of “Taiwanese language” corresponding to the language attribute number “4” is stored. Moreover, the language attribute of “English language” corresponding to the language attribute number “5” is stored.

In addition, although the language attributes of FIG. 3 are stored in the ECR 11 in the present embodiment, it is not limited thereto, and may be in another device such as the controller box 13.

FIG. 4 is a table illustrating an example of work attributes stored in the ECR 11. The work attributes stored in the ECR 11 include the information of work corresponding to every work attribute number. Therefore, it is sufficient if the structure of the work attributes stored in the ECR 11 shows such a relationship, and is not particularly limited; however, in the present embodiment, it is made in a matrix structure as shown in FIG. 4.

More specifically, the work attribute of “manager” corresponding to work attribute number “1” is stored. Manager refers to the job of a person carrying out work to direct the employees working in the shop serving food and drink. In addition, the work attribute of “cook” corresponding to work attribute number “2” is stored. Cook refers to the job of a person working inside of the kitchen of the shop serving food and drink. Furthermore, the work attribute of “server” corresponding to work attribute number “3” is stored. Server refers to the job of a person who accepts orders at guest seats and provides the prepared cuisine to the customer. Moreover, the work attribute of “dishwasher” corresponding to work attribute number “4” is stored. Dishwasher refers to the job of a person who washes the dishes, pots, etc. used in the shop serving food and drink. Additionally, the work attribute of “cleaner” corresponding to work attribute number “5” is stored. Cleaner refers to the job of a person who cleans inside of the shop serving food and drink.

Furthermore, although the work attributes of FIG. 4 are stored in the ECR 11 in the present embodiment, it is not limited thereto, and may be in another device such as the controller box 13.

FIG. 5 is a table illustrating an example of deployment attributes stored in the controller box 13. The deployment attributes stored in the controller box 13 include information of deployments corresponding to every deployment number. Therefore, it is sufficient if the structure of deployment attributes stored in a storage unit 34 shows such a relationship, and is not particularly limited; however, in the present embodiment, it is made in a matrix structure as shown in FIG. 5.

More specifically, the deployment attribute of “appetizers” corresponding to deployment number “1” is stored. Appetizers refers to a position for undertaking preparation of the cuisine of antipastos or hors d′oeuvres. In addition, the deployment attribute of “main” corresponding to deployment number “2” is stored. Main refers to a position undertaking the preparation of the main course. Furthermore, the deployment attribute of “dessert” corresponding to deployment number “3” is stored. Desserts refers to a position undertaking the preparation of desserts such as pastry and fruits presented at the end of a meal. Additionally, the deployment attribute of “other” corresponding to deployment number “4” is stored. Other refers to a position not belonging to any of deployment attributes 1 to 3.

Moreover, although the deployment attributes of FIG. 5 are stored in the controller box 13 in the present embodiment, it is not limited thereto, and may be in another device such as the ECR 11.

Next, the configurations of such an ECR 11 and controller box 13 of the present embodiment will be explained.

ECR 11

FIG. 6 is a block diagram showing the configuration of hardware of the ECR 11 according to the present embodiment.

The ECR 11 is provided with a CPU (Central Processing Unit) 21, ROM (Read Only Memory) 22, RAM (Random Access Memory) 23, a bus 24, an input/output interface 25, an input unit 26, an output unit 27, a storage unit 28, a communication unit 29, and a drive 30.

The CPU 21 executes various types of processing according to programs that are recorded in the ROM 22 or programs that are loaded from the storage unit 28 into the RAM 23.

The RAM 23 also stores data and the like necessary for the CPU 21 to execute the various types of processing, as appropriate.

The CPU 21, ROM 22 and RAM 23 are connected to each other via the bus 24. In addition, the input/output interface 25 is also connected to this bus 24. The input unit 26, output unit 27, storage unit 28, communication unit 29 and drive 30 are connected to the input/output interface 25.

The input unit 26 is configured by various buttons and the like, and inputs various information in response to an instruction operation of the user.

The output unit 27 is configured by a display and a printing unit, and outputs various information such as the bill by displaying or printing.

The storage unit 28 is configured by a hard disk, DRAM (Dynamic Random Access Memory), or the like, and stores various data.

In addition to controlling communication carried out with the controller box 13 via the HUB 12, the communication unit 29 controls communication carried out with another device via the internet or the like (not illustrated).

Removable media 31 composed of a magnetic disk, optical disk, magneto-optical disk, semiconductor memory, or the like is installed in the drive 30 as appropriate. Programs read from the removable media 31 by the drive 31 are installed in the storage unit 28 as necessary. Similarly to the storage unit 28, the removable media 31 can also store a variety of data such as the data of images stored in the storage unit 28.

It should be noted that the ECR 11 is provided with a drawer (not illustrated) that stows money received from customers.

### Controller Box 13

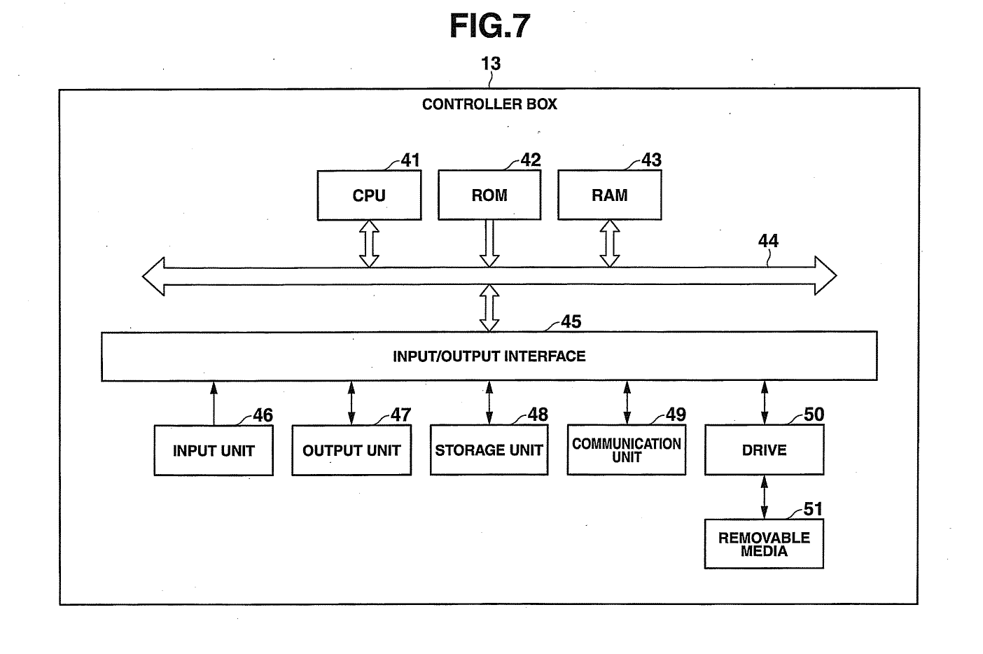

FIG. 7 is a block diagram showing the configuration of hardware of the controller box 13 according to the present embodiment.

The controller box 13 includes the CPU 41 to drive 50. Each of the CPU 41 to drive 50 has basically the same function and configuration as each of the aforementioned CPU 21 to drive 30 in FIG. 6. Therefore, separate explanations for the CPU 41 to drive 50 will be omitted herein.

It should be noted that, in addition to controlling communication carried out with the ECR 11 via the HUB 12, the communication unit 49 controls wireless communication with the handy terminal 14, and controls communication carried out with other devices via the Internet or the like (not illustrated), and communication carried out with the printer 15 and display 16.

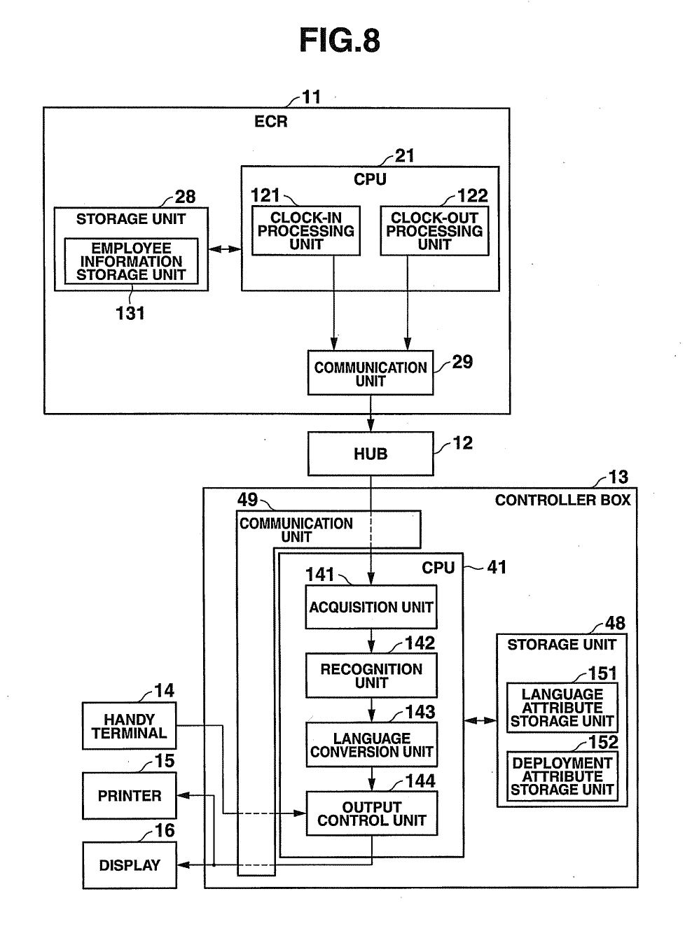

FIG. 8 is a functional block diagram showing, among the functional configurations of the ECR 11 and controller box 13, the functional configurations for executing clock-in processing, clock-out processing, language information conversion processing and order information output processing.

The clock-in processing refers to the following such sequence of processing. Specifically, it refers to the sequence of processing until the ECR 11 determines the attributes of an employee based on the personal identification number input accompanying clocking in of the employee, and based on the determination results thereof, transmits an instruction to add the language attribute to the controller box 13.

Clock-out processing refers to the following such sequence of processing. Specifically, it refers to the sequence of processing until the ECR 11 determines the attributes of an employee based on the personal identification number input accompanying clocking out of the employee, and based on the determination results thereof, transmits an instruction to delete the language attribute to the controller box 13.

Language information conversion processing refers to the following such sequence of processing. Specifically, it refers to the sequence of processing of the controller box 13 to convert the status of language attributes set for every product so as to correspond to the clock in/out information transmitted from the ECR 11.

Order information output processing refers to the following such sequence of processing. Specifically, it refers to the sequence of processing of the controller box 13 to output an order slip based on the status of the language attributes converted for every deployment, on the occasion of receipt of order information transmitted from the handy terminal 14.

In a case of clock-in processing being executed by the ECR 11, a clock-in processing unit 121 functions in the CPU 21, while in a case clock-out processing being executed by the ECR 11, a clock-out processing unit 122 functions in the CPU 21.

In addition, an employee information storage unit 131 in which the respective information shown in each of the aforementioned FIGS. 2 to 4 is stored is provided as one area of the storage unit 28. It should be noted that the employee information storage unit 131 being provided as one area of the storage unit 28 is an exemplification, and as another example, may be configured so as to be provided as one area of the removable media 31.

The clock-in processing unit 121 produces an instruction to add a language attribute, by executing check-in processing based on various information stored in the employee information storage unit 131, and transmits this instruction from the communication unit 29 to the controller box 13 via the HUB 12.

The clock-out processing unit 122 produces an instruction to delete a language attribute by executing clock-out processing based on various information stored in the employee information storage unit 131, and transmits this instruction from the communication unit 29 to the controller box 13 via the HUB 12.

In a case of language information conversion processing and order information output processing being executed by the controller box 13, an acquisition unit 141, recognition unit 142, language conversion unit 143 and output control unit 144 function in the CPU 41.

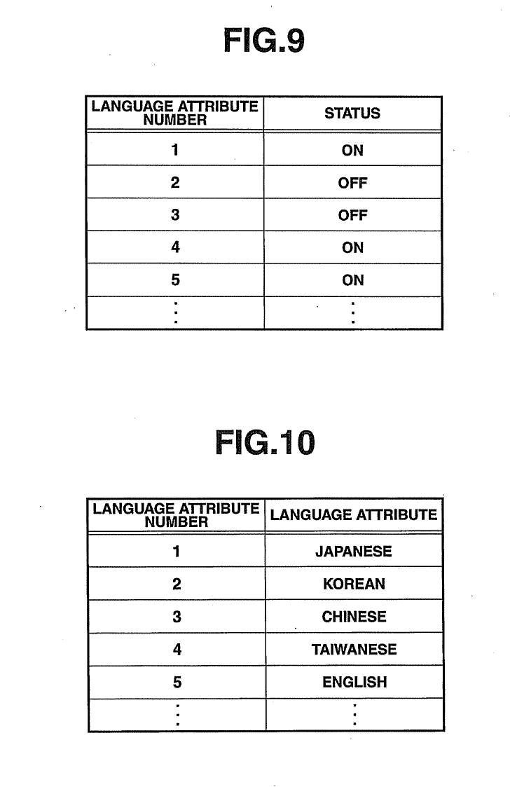

A language attribute storage unit 151 in which the language attributes of FIGS. 9 and 10 described later are stored, and a deployment attribute storage unit 152 in which the deployment attributes of the aforementioned FIG. 5 are stored are provided as an area of the storage unit 48. It should be noted that the language attribute storage unit 151 being provided as one area of the storage unit 48 is an exemplification, and as another example, may be configured so as to be provided as one area of the removable media 51.

The acquisition unit 141 acquires clock in/out information including an instruction to add a language attribute number or an instruction to delete a language attribute number, transmitted from the ECR 11. This clock in/out information is acquired by the acquisition unit 141 for each of a plurality of target persons for which the language of accepted information is set in advance.

Upon outputting an order slip, the recognition unit 142 recognizes the position of an employee present at a location at which an order slip should be output. More specifically, the recognition unit 142 refers to deployment attribute numbers based on the clock in/out information acquired by the acquisition unit 141, and recognizes the position of a clocked-in employee (cook) working in the kitchen.

The language conversion unit 143 determines a clocked-in employee and the position thereof, based on clock in/out information acquired by the acquisition unit 141 and information of the position of the employee recognized by the recognition unit 142, and converts the language of an output target to the language set for the clocked-in employee present at this position, based on a referenced language attribute.

When order information transmitted from the handy terminal 14 is received, the output control unit 144 executes control to cause an order slip to be output by printing from the printer 15, in at least one language including at least the language converted by the language conversion unit 143. In addition, the output control unit 144 executes control to cause the order slip to be output by displaying on the display 16 in at least one language including at least the language converted by the language conversion unit 143.

FIG. 9 is a table illustrating an example of the statuses stored at every position of target persons, in the information file stored in the language attribute storage unit 151. The statuses stored in the language attribute storage unit 151 include information of either status of “ON” or “OFF”, corresponding to every language attribute number. Therefore, it is sufficient if the structure of statuses stored in the language attribute storage unit 151 shows such a relationship, and is not particularly limited; however, in the present embodiment, it is made in a matrix structure, as shown in FIG. 9.

More specifically, in a case of the status corresponding to a certain language attribute number being “ON”, the language of the language attribute corresponding to this language attribute number (refer to FIG. 10) is outputted. In contrast, in a case of the status corresponding to a certain language attribute number being “OFF”, the language of the language attribute corresponding to this language attribute number (refer to FIG. 10) is not outputted.

FIG. 10 is a table illustrating an example of language attributes in an information file stored in the language attribute storage unit 151. The language attributes stored in the language attribute storage unit 151 include information of languages corresponding to every language attribute number. Therefore, it is sufficient if the structure of language attributes stored in the language attribute storage unit 151 shows such a relationship, and is not particularly limited; however, in the present embodiment, it is made in a matrix structure, as shown in FIG. 10.

More specifically, the language attribute of “Japanese language” corresponding to the language attribute number “1” is stored.

In addition, the language attribute of “Korean language” corresponding to the language attribute number “2” is stored. Furthermore, the language attribute of “Chinese language” corresponding to the language attribute number “3” is stored. Additionally, the language attribute of “Taiwanese language” corresponding to the language attribute number “4” is stored. Moreover, the language attribute of “English language” corresponding to the language attribute number “5” is stored.

In addition, although the language attributes of FIG. 10 are stored in the language attribute storage unit 151 of the controller box 13 in the present embodiment, it is not limited thereto, and may be in another device such as the ECR 11.

Hereinafter, clock-in processing of the ECR 11 will be explained while referencing the flowchart of FIG. 11.

FIG. 11 is a flowchart illustrating a flow sequence of clock-in processing executed by the ECR 11 having the functional configuration of FIG. 8.

When clock-in processing is executed by the ECR 11, each functional block of FIG. 8 functions in the CPU 21, and the following such processing is executed. In other words, in terms of hardware, the executor for the processing of each of the following steps is the CPU 21. However, in order to facilitate understanding of the present invention, an explanation of the processing of each of the following steps will be provided, with each functional block functioning in the CPU 21 as the executor.

An employee can make a stamp of the clock-in time by operating the input unit 26 (FIG. 6) of the ECR 11 to input the personal identification number. Herein, at least the time when clocking in is included in the information stamped at the clock-in time.

The clock-in processing of the ECR 11 is initiated on the occasion of such stamping of the clock-in time by the employee, whereby the following such processing is executed.

In Step S11, the clock-in processing unit 121 of the ECR 11 accepts the input of the personal identification number by an employee.

In Step S12, the clock-in processing unit 121 determines whether or not the personal identification number corresponding to that accepted in the processing of Step S11 is in the clock in/out information of FIG. 2 stored in the employee information storage unit 131.

In a case of there not being a corresponding personal identification number, it is determined as being NO in Step S12, and the clock-in information processing comes to an end. In other words, in this case, the clock-in processing is terminated, with an error being generated due to the inputted personal identification number being wrong, or a person other than an employee trying to operate the time recorder.

In contrast, in a case of there being a corresponding personal identification number, it is determined as being YES in Step S12, and the processing advances to Step S13. It should be noted that, in this case, the clock-in processing unit 121 updates the clock-in information of a character corresponding to this personal identification number to “YES” in the clock in/out information.

In Step S13, the clock-in processing unit 121 determines whether the work attribute number corresponding to the character of the employee is “2”, by referencing the clock in/out information of FIG. 2. In this processing, it is determined whether the clock-in processing employee is a cook, i.e. whether this employee is a person working in the kitchen.

In a case of the work attribute number of the employee not being “2”, it is determined as being NO in Step S13, and the clock-in processing is terminated. In other words, in a case of the clocking-in employee not being a cook, normal clock-in processing to carry out only stamping of the clock-in time is performed.

In contrast, in a case of the work attribute number of the employee being “2”, i.e. in a case of the clocking-in employee being a cook, it is determined as being YES in Step S13, and the processing advances to Step S14.

In Step S14, the clock-in processing unit 121 determines whether a cook of a language attribute (language attribute number) that is the same as the clock-in processing employee (cook) is clocked in, by referencing the clock in/out information of FIG. 2. In this processing, among the employees of a language attribute (language attribute number) that is the same as the clock-in processing employee (cook), it is determined whether there is another employee having clock-in of YES, i.e. whether another cook having the same working language is clocked in.

In a case of an employee (cook) of the same language attribute (language attribute number) being clocked in, it is determined as being YES in Step S14, and the clock-in processing comes to an end. In other words, in this case, since a cook using the same working language is already present, it is sufficient even if not transmitting information of the language attribute number corresponding to the working language of the clock-in processing cook to the controller box 13; therefore, the wasteful processing of transmitting again can be omitted.

In contrast, in a case of an employee (cook) of the same language attribute (language attribute number) not being clocked in, it is determined as being NO in Step S14, and the processing advances to Step S15.

In Step S15, the clock-in processing unit 121 determines whether a cook of a deployment position that is the same as the clock-in processing employee (cook) is clocked in, by referencing the clock in/out information of FIG. 2. In this processing, it is determined whether another cook working at the same deployment as the clock-in processing employee (cook), i.e. same deployment position, is clocked in.

In a case of an employee (cook) of the same deployment position being clocked in, it is determined as being YES in Step S15, and the clock-in processing comes to an end. In other words, in this processing, since a cook of the same deployment position is already present, it is sufficient even if not transmitting information of the language attribute number corresponding to the working language of the clock-in processing cook to the controller box 13; therefore, the wasteful processing of transmitting again can be omitted.

In contrast, in a case of an employee (cook) of the same deployment position not being clocked in, it is determined as being NO in Step S15, and the processing advances to Step S16.

In Step S16, the clock-in processing unit 121 transmits, to the controller box 13, clock in/out information including an instruction to add the language attribute number corresponding to the character of the employee at the deployment. In this processing, in a case of the clock-in processing employee being a cook, the language attribute (language attribute number) indicating the language used by this cook at this deployment is transmitted to the controller box 13. Information of the deployment number of this employee is also included in the clock in/out information to be transmitted. When such processing of Step S16 ends, the clock-in processing of the ECR 11 ends.

In a case of an employee clocking out, clock-out processing of the ECR 11 shown in FIG. 12 is executed separately from such clock-in processing of the ECR 11.

FIG. 12 is a flowchart illustrating a flow sequence of clock-out processing executed by the ECR 11 having the functional configuration of FIG. 8.

When the clock-out processing is executed by the ECR 11, each functional block of FIG. 8 functions in the CPU 21, and the following such processing is executed. In other words, in terms of hardware, the executor for the processing of each of the following steps is the CPU 21. However, in order to facilitate understanding of the present invention, an explanation of the processing of each of the following steps will be provided, with each functional block functioning in the CPU 21 as the executor.

An employee can make a stamp of the clock-out time by operating the input unit 26 (FIG. 6) of the ECR 11 to input the personal identification number. Herein, at least the time when clocking out is included in the information stamped at the clock-out time.

The clock-out processing of the ECR 11 is initiated on the occasion of such stamping of the clock-out time by the employee, whereby the following such processing is executed.

In Step S31, the clock-out processing unit 122 of the ECR 11 accepts the input of the personal identification number by an employee.

In Step S32, the clock-out processing unit 122 determines whether or not the personal identification number corresponding to that accepted in the processing of Step S31 is in the clock in/out information of FIG. 2 stored in the employee information storage unit 131.

In a case of there not being a corresponding personal identification number, it is determined as being NO in Step S32, and the clock-out information processing comes to an end. In other words, in this case, the clock-out processing is terminated, with an error being generated due to the inputted personal identification number being wrong, or a person other than an employee trying to operate the time recorder.

In contrast, in a case of there being a corresponding personal identification number, it is determined as being YES in Step S32, and the processing advances to Step S33. In this case, the clock-out processing unit 122 updates the clock-in information of a character corresponding to this personal identification number to “NO” in the clock in/out information.

In Step S33, the clock-out processing unit 122 determines whether a duty attribute (work attribute number) corresponding to the character of the employee is “2”, by referencing the clock in/out information of FIG. 2. In this processing, it is determined whether the clock-out processing employee is a cook, i.e. whether this employee is a person working in the kitchen. In a case of the work attribute number of the employee not being “2”, it is determined as being NO in Step S33, and the clock-out processing is terminated. In other words, in a case of the clocking-out employee not being a cook, normal clock-out processing to carry out only stamping of the clock-out time is performed.

In contrast, in a case of the work attribute number of the employee being “2”, i.e. in a case of the clocking-out employee being a cook, it is determined as being YES in Step S33, and the processing advances to Step S34.

In Step S34, the clock-out processing unit 122 determines whether an employee (cook) of a language attribute (language attribute number) that is the same as the clock-out processing employee (cook) is clocked in, by referencing the clock in/out information of FIG. 2. In this processing, among the employees of a language attribute (language attribute number) that is the same as the clock-out processing cook, it is determined whether there is another employee having clock-in of YES, i.e. whether another cook having the same working language is clocked in.

In a case of a cook of the same language attribute (language attribute number) being clocked in, it is determined as being YES in Step S34, and the clock-out processing comes to an end. In other words, in this case, since another cook using the same working language is clocked in, it is sufficient even if not transmitting information of the language attribute number corresponding to the working language of the clock-out processing cook to the controller box 13; therefore, the wasteful processing of transmitting again can be omitted.

In contrast, in a case of an employee (cook) of the same language attribute (language attribute number) not being clocked in, it is determined as being NO in Step S34, and the processing advances to Step S35.

In Step S35, the clock-out processing unit 122 determines whether a cook of a deployment position that is the same as the clock-in processing employee (cook) is clocked in, by referencing the clock in/out information of FIG. 2.

In this processing, it is determined whether another cook working at the same deployment as the clock-in processing employee (cook), i.e. same deployment position, is clocked in. In a case of an employee (cook) of the same deployment position being clocked in, it is determined as being YES in Step S35, and the clock-out processing comes to an end. In other words, in this processing, since a cook of the same deployment position is already present, it is sufficient even if not transmitting information of the language attribute number corresponding to the working language of the clock-out processing cook to the controller box 13; therefore, the wasteful processing of transmitting again can be omitted.

In contrast, in a case of an employee (cook) of the same deployment position not being clocked in, it is determined as being NO in Step S35, and the processing advances to Step S36.

In Step S36, the clock-out processing unit 122 transmits, to the controller box 13, clock in/out information including an instruction to delete the language attribute number corresponding to the character of the employee at the deployment. In this processing, in a case of the clock-out processing employee being a cook, the language attribute (language attribute number) indicating the language used by this cook at this deployment is transmitted to the controller box 13. Information of the deployment number of this employee is also included in the clock in/out information to be transmitted. When such processing of Step S36 ends, the clock-out processing of the ECR 11 ends.

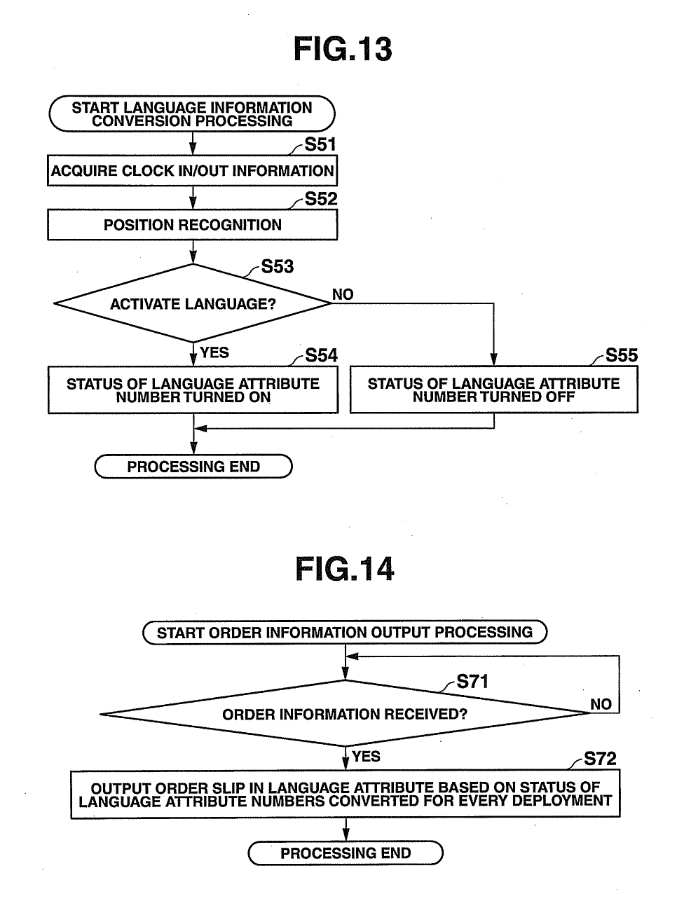

Next, the language information conversion processing of the controller box 13 will be explained while referencing the flowchart of FIG. 13.

FIG. 13 is a flowchart illustrating a flow sequence of language information conversion processing executed by the controller box 13 having the functional configuration of FIG. 8.

When the language information conversion processing is executed by the controller box 13, each functional block of FIG. 8 functions in the CPU 41, and the following such processing is executed. In other words, in terms of hardware, the executor for the processing of each of the following steps is the CPU 41. However, in order to facilitate understanding of the present invention, an explanation of the processing of each of the following steps will be provided, with each functional block functioning in the CPU 41 as the executor.

The language information conversion processing is initiated on the occasion of an instruction to add a language attribute number transmitted in Step S16 of FIG. 11 or an instruction to delete a language attribute number transmitted in Step S36 of FIG. 12 being received at the communication unit 49 of the controller box 13, whereby the working language is converted by the following such processing being executed. In other words, in the present embodiment, the following such processing is repeatedly executed every time the communication unit 49 receives clock in/out information, whereby the working language is converted.

In Step S51, the acquisition unit 141 acquires clock in/out information including an instruction to add or an instruction to delete a language attribute number transmitted from the ECR 11.

In Step S52, the recognition unit 142 recognizes the deployment attribute of a clocked-in employee working in the kitchen, i.e. position of the employee, based on the deployment number of this employee included in the clock in/out information.

In Step S53, the language conversion unit 143 determines whether the language of the deployment recognized in the processing of Step S52 is set to active. More specifically, the language conversion unit 143 determines if an instruction to add a language attribute number has been received, or an instruction to delete a language attribute number has been received, based on the clock in/out information acquired in the processing of Step S51. In a case of having received an instruction to add a language attribute number, it is determined to activate the language of this employee at this deployment, and it is determined as being YES in Step S53, then the processing advances to Step S54.

In Step S54, the language conversion unit 143 switches the status corresponding to the language attribute numbers of FIG. 9 stored for every position of employees, i.e. deployment attribute of employees, stored in the language attribute storage unit 151 to ON. When such processing of Step S54 ends, the language information conversion processing ends.

In contrast, in a case of having received an instruction to delete a language attribute number, it is determined to inactivate the language of this employee at this position, and it is determined as being NO in Step S53, then the processing advances to Step S55.

In Step S55, the language conversion unit 143 switches the status corresponding to the language attribute number of FIG. 9 stored for every position of employees, i.e. deployment attribute of employees, stored in the language attribute storage unit 151 to OFF.

When such processing of Step S55 ends, the language information conversion processing ends.

Hereinafter, order information output processing of the controller box 13 will be explained while referencing the flowchart of FIG. 14.

FIG. 14 is a flowchart illustrating a flow sequence of order information output processing executed by the controller box 13 having the functional configuration of FIG. 8.

When the order information output processing is executed by the controller box 13, each functional block of FIG. 8 functions in the CPU 41, and the following such processing is executed. In other words, in terms of hardware, the executor for the processing of each of the following steps is the CPU 41. However, in order to facilitate understanding of the present invention, an explanation of the processing of each of the following steps will be provided, with each functional block functioning in the CPU 41 as the executor.

The order information output processing is initiated on the occasion of order information transmitted from the handy terminal 14 being received, whereby the following such processing is executed.

In Step S71, the output control unit 144 determines whether order information has been received. In a case of the reception of order information not being able to be confirmed, it is determined as being NO in Step S71, and the processing returns to Step S71. In other words, in a period until order information arrives from the handy terminal 14, the determination processing of Step S71 is repeatedly executed, and the order information output processing enters a standby state.

In Step S72, the output control unit 144 outputs an order slip, based on the status of the language attribute number switched for every deployment, to the printer 15 or display 16 at this deployment.

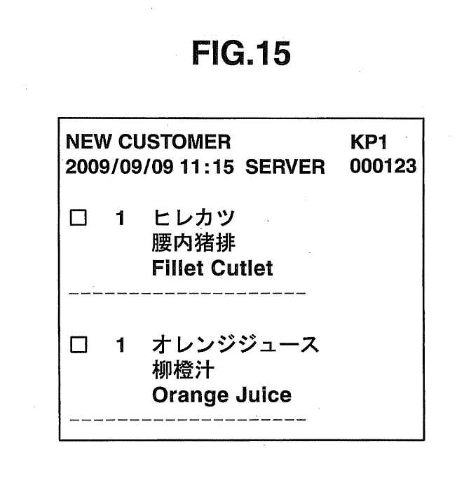

When such processing of Step S72 ends, the order information output processing ends. In the present embodiment, it is thereby possible to output the minimum requirement of information to the printer 15 and display 16 based on the working languages of the clocked-in employees, irrespective of the working languages of employees attending tables in the shop serving food and drink, as shown in FIG. 15.

FIG. 15 shows an example of an order slip outputted from the printer 15 of FIG. 1. It should be noted that, although an example of an order slip outputted from the printer 15 is explained in the present embodiment, since the display screen outputted by displaying on the display 16 would be the same output result, an explanation thereof is omitted herein.

FIG. 15 shows an output example from the printer 15, in a case of the order information of “cutlet” and “orange juice” having been received from the handy terminal 14 when “Tarou Yamada”, “Cangbai Li” and “Elizabeth” are clocked in as employees.

In a case of “Tarou Yamada”, “Cangbai Li”, and “Elizabeth” operating the ECR 11 when clocking in, the clock-in processing of FIG. 11 is performed. In this case, in Step S16 of FIG. 11, as the language attribute corresponding to the language attribute number “1” of “Tarou Yamada”, an instruction to add the language attribute number of “Japanese language” is transmitted, by referencing the language attributes of FIG. 3. Similarly, in Step S16 of FIG. 11, as the language attribute corresponding to the language attribute number “3” of “Cangbai Li”, an instruction to add the language attribute number of “Chinese language” is transmitted, by referencing the language attributes of FIG. 3. Similarly, in Step S16 of FIG. 11, as the language attribute corresponding to the language attribute number “5” of “Elizabeth”, an instruction to add the language attribute number of “English language” is transmitted, by referencing the language attributes of FIG. 3. Then, the controller box 13 having received the instructions to add the respective language attribute numbers switches the statuses corresponding to the respective language attribute numbers to ON. (Step S54).

Furthermore, the controller box 13, in a case of having received order information from the handy terminal 14 (Step S71: YES), outputs an order slip based on the status of language attribute numbers switched for every deployment (Step S72). In other words, in this case, an order slip is outputted from the printer 15 in each of the language attributes “Japanese language”, “Chinese language” and “English language” of the statuses corresponding to each of the respective language attribute numbers “1”, “3” and “5” for “Tarou Yamada”, “Cangbai Li” and “Elizabeth”.

More specifically, as shown in FIG. 15, “hirekatsu” corresponding to the language attribute of “Japanese language”, “yao nei zhu pai” corresponding to the language attribute of “Chinese language”, and “fillet cutlet” corresponding to “English language” are respectively outputted. Similarly, “orenji jyu-su” corresponding to the language attribute of “Japanese language”, “liu cheng zhi” corresponding to the language attribute of “Chinese language”, and “orange juice” corresponding to “English language” are respectively outputted.

As explained in the foregoing, the acquisition unit 141, language conversion unit 143, and output control unit 144 function in the CPU 41 of the controller box 13, serving as an embodiment of an information processing device of the present invention.

The acquisition unit 141 acquires clock in/out information of a plurality of employees for which the language of accepted information has been set in advance.

The language conversion unit 143 determines a clocked in employee based on the clock in/out information acquired by the acquisition unit 141, and converts the language of an output target to the language set for the clocked in employee.

The output control unit 144 executes control to output an order slip in the language converted by the language conversion unit 143.

In this case, it is possible to convert to the working language of this clocked in employee based on the clock in/out information of employees. As a result, it is possible to output only an order slip based on the language used by a presently clocked in employee. Therefore, since it is possible to output an order slip in only the minimum required languages for work, even in a situation in which employees using a plurality of languages are working, the outputted information can be prevented from becoming unnecessarily lengthy. Therefore, it is possible to enable the output of an order slip containing the minimum requirement of information, irrespective of the working languages of employees involved in work.

In addition, the output control unit 144 may execute control to output an order slip listing both writing according to the language converted by the language conversion unit 143, and writing according to a fixed language. In this case, a fixed specific language can always be outputted. Therefore, by always listing writing according to the official language (e.g., Japanese, English, etc.) of the country in which this controller box 13 is used, information can be outputted according to the same language, irrespective of the clock-in situation of employees. It is thereby possible to inhibit confusion over the changed languages, irrespective of the clock-in situation of employees. In addition, by setting the fixed language in advance, it is always possible for a specific person such as the manager to confirm the work contents, irrespective of the clock-in situation of employees.

The output control unit 144 may execute control to print an order slip at the printer 15, based on the language converted by the language conversion unit 143. In this case, it is possible to print the order slip based on the working language of the clocked in employees. Therefore, since it is possible to print the order slip in only the minimum required language for work, even in the situation of employees using a plurality of languages working, the outputted information can be prevented from becoming unnecessarily lengthy. Therefore, it is possible to print an order slip containing the minimum requirement of information, irrespective of the working languages of employees involved in work.

The output control unit 144 may execute control to display an order slip on the display 16 based on the languages converted by the language conversion unit 143.

In this case, it is possible to display the order slip on the display 16, based on the working languages of clocked in employees. Therefore, since it is possible to display an order slip in only the minimum required languages for work, even in a situation in which employees using a plurality of languages are working, the displayed order slip can be prevented from becoming unnecessarily lengthy. Therefore, it is possible to display the minimum required order slip, irrespective of the working languages of employees involved in work.

The controller box 13 may further include a storage unit 48 (more specifically, language attribute storage unit 151) storing information files including the language attributes of employees at every position of target persons. In this case, the language conversion unit 143 can convert a language by referencing language attributes corresponding to clocked in employees at every position of target persons, from the clock in/out information of employees stored in the storage unit 48 (more specifically, language attribute storage unit 151).

In this case, the controller box 13 can convert to a corresponding language by simply acquiring from the ECR 11 only information corresponding to the language attributes to be converted.

The acquisition unit 141 may acquire clock in/out information outputted from an external device such as the ECR 11.

In this case, the controller box 13 can convert a language in which to output information, based on the clock in/out operations usually performed by employees. Therefore, it is possible to output the minimum required information, without requiring a separate input operation or the like by the employee.

The language conversion unit 143 may convert a language each time the acquisition unit 141 acquires clock in/out information.

In this case, the controller box 13 can convert a language in which to output information, based on every clock in/out operation normally performed by employees. Therefore, it is possible to output the minimum required information, without requiring a separate input operation or the like by the employee.

It may be configured so that the recognition unit 142 recognizing the positions of employees present at a location to output information further functions in the CPU 41 of the controller box 13. In this case, the output control unit 144 executes control to output an order slip, in the language set for a target person present at the position recognized by the recognition unit 142.

In this case, the controller box 13 can convert a language in which to output the order slip at every position of employees. Therefore, since it is possible to output an order slip in only the languages required at a position having a direct relationship with the employee, the outputted information can be prevented from becoming unnecessarily lengthy. Therefore, it is possible to enable the output a minimum required order slip, irrespective of the working languages of employees involved in work.

The recognition unit 142 may recognize the position of a target person by reading an identification medium of an employee present in the vicinity of a device such as the printer 15 or display 16 outputting the order slip. In addition, the output control unit 144 may execute control to output an order slip, in the language set for an employee present at the position recognized by the recognition unit 142.

In this case, the controller box 13 can output the order slip in only the languages needed by the employees present in the vicinity of a device such as the printer 15 or display 16 outputting the order slip; therefore, it is possible to prevent the outputted information from becoming unnecessarily lengthy. Therefore, it is possible to enable the output of the minimum required order slip, irrespective of the working languages of employees involved in work.

It should be noted that the present invention is not limited to the aforementioned embodiments, and that modification, improvements, etc. within a scope that can achieve the object of the present invention are included in the present invention.

Although the working language is converted based on the language attributes of clocked in employees, based on clock in/out information in the aforementioned embodiment, it is not limited thereto. In other words, it may be configured so that writing according to a specific language (e.g., “Japanese language”) is always outputted without conversion, and it may be configured so as to always both list writing according to another language and writing according to the Japanese language.

In addition, although “m” number of the printers 15 and the displays 16 are arranged in the aforementioned embodiment, it is not limited thereto, and each may be arranged so as to be different numbers, and it may be configured so that one is arranged at every plurality of cooking areas, without arranging at all “m” number of cooking stations.

Furthermore, although the position of an employee is recognized based on the clock in/out information of FIG. 2 in the aforementioned embodiment, it is not particularly limited thereto, and the position of an employee (cook) may be recognized by reading the identification medium of a target person that is in the vicinity of the printer 15 or display 16. The identification medium may simply be a medium that can identify each employee such as an IC chip or token. Additionally, it is not limited to a case of recognizing the position of each employee using identification media, and the position of each employee may be recognized by identifying each employee by way of biometric identification such as fingerprints, iris, voice, or facial recognition, for example.

Moreover, although the information processing system to which the present invention is applied has been explained as a system that performs control to output or display order information of cuisine accepted at the guest seating of a shop serving food and drink, on “m” number of terminals arranged in the kitchen in the aforementioned embodiment, it is not particularly limited thereto.

For example, the present invention can be applied to a general information processing system in which orders are necessary. More specifically, the present invention is applicable to order systems such as of restaurants, amusement parks, hotels, and factories, for example.

Furthermore, the configuration of the information processing system to which the present invention is applied is not limited to the aforementioned configuration of FIG. 1, for example.

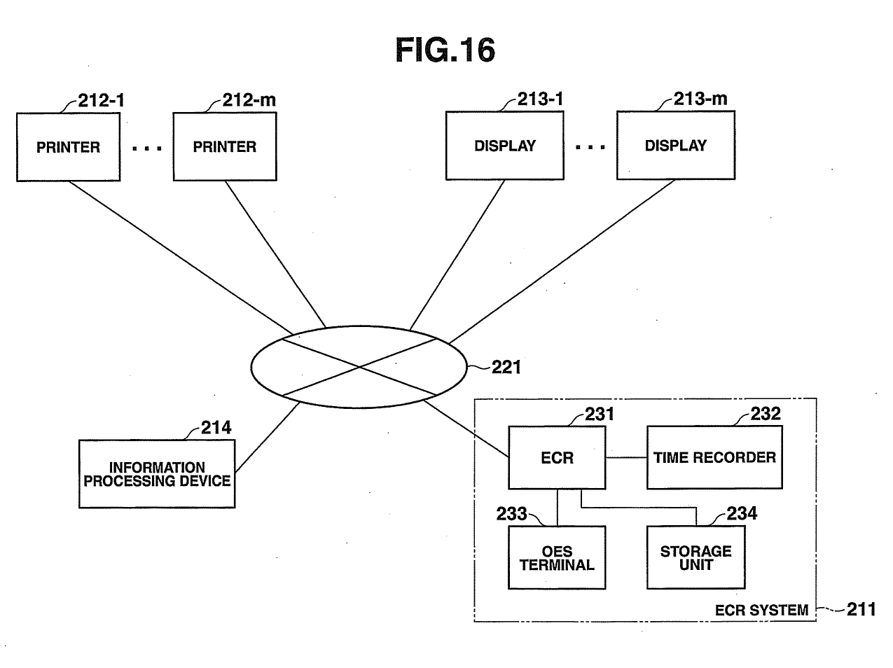

FIG. 16 shows the configuration of an information processing system according to an embodiment of the present invention differing from the embodiment of FIG. 1.

In the information processing system shown in FIG. 16, an ECR system 211, printers 212-1 to 212-m and displays 213-1 to 213-m arranged at every “m” number of cooking areas in the kitchen, and an information processing device 214 are connected together via a network 221 by way of a HUB (not illustrated) or the like. The network 221 connects together each terminal wirelessly or with wires by way of LAN wires or internet wires.

The ECR system 211 includes an ECR 231, time recorder 232, OES (Order Entry System) terminal 233, and storage unit 234.

The ECR 231 has basically the same functions and configuration as the ECR 11 of FIG. 1. In other words, the ECR 231 has the same hardware configuration as FIG. 6, and has the same functional configuration as FIG. 8. However, in the example of FIG. 16, the time recorder 232 is specially provided. The time recorder 232 accepts operations of employees at the clock-in time and clock-out time of employees, and executes processing to stamp the time of this clock-in time or clock-out time. The time recorder 232 transmits the stamped time to the information processing device 214 via the ECR 231.

The OES terminal 233 basically has the same functions and configuration as the handy terminal 14 of FIG. 1. In other words, when accepting and registering the order of a patron, the OES terminal 233 transmits order information indicating this order to the ECR 231. Then, the ECR 231 transmits this order information to the information processing device 214.

The employee attribute storage unit 131, language attribute storage unit 151, and deployment attribute storage unit 152 of FIG. 8 are provided in an area of the storage unit 34.

The information processing device 214 has basically the same functions and configuration as the controller box 13 of FIG. 1. In other words, the information processing device 214 has the same hardware configuration as FIG. 7 and has the same functional configuration as FIG. 8.

The aforementioned sequence of processing can be made to either be executed by hardware or executed by software. That is, the functional configuration in FIG. 8 is merely an example and is not particularly limiting. In other words, it is sufficient that any device of the information processing system be provided with functions capable of executing the aforementioned sequence of processing as a whole, and the kinds of functional blocks used in order to realize these functions are not particularly limited to the example in FIG. 8.

In addition, the individual functional blocks may be configured by hardware units, may be configured by software units, and may be configured by combinations thereof.

If a sequence of processing is executed by software, a program constituting the software is installed to the computer or the like from a network or a recording medium.

The computer may be a computer incorporating special-purpose hardware.

In addition, the computer may be a computer capable of executing various functions by installing various programs, for example, a general-purpose personal computer.

The recording medium containing such a program is configured not only by the removable media 31 in FIG. 6 and the removable media 51 in FIG. 7 that are distributed separately from the main body of the device in order to provide the program to the user, but also is configured by a recording medium provided to the user in a state incorporated in the main body of the equipment in advance, or the like. The removable media 31 and 51 is constituted by, for example, a magnetic disk (including floppy disks), an optical disk, a magneto-optical disk or the like. The optical disk is, for example, a CD-ROM (Compact Disk-Read Only Memory), DVD (Digital Versatile Disk), or the like. The magneto-optical disk is, for example, an MD (Mini-Disk), or the like. In addition, the recording medium provided to the user in a state incorporated with the main body of the equipment in advance is constituted by the ROM 22 of FIG. 6, ROM 42 of FIG. 7 in which a program is recorded, a hard disk included in the storage unit 48 of FIG. 7, or the like.

It should be noted that the steps describing the program recorded in the recording medium naturally include only processing performed chronologically in the described order, but is not necessarily processed chronologically, and also includes processing executed in parallel or separately.

Furthermore, the terminology of system in the present specification is intended to mean the overall equipment configured by a plurality of devices, a plurality of means, etc.

Although several embodiments of the present invention have been explained in the foregoing, these embodiments are merely exemplifications, and are not to limit the technical scope of the present invention. The present invention can adopt various other embodiments, and further, various modifications such as omissions and substitutions can be made thereto within a scope that does not deviate from the gist of the present invention. These embodiments and modifications thereof are included in the scope and gist of the invention described in the present disclosure, and are included in the invention described in the accompanying claims and the scope of equivalents thereof.

What is claimed is:

1. An information processing device, comprising:
an acquisition unit that acquires an attribute of a target person accepting information;
a language conversion unit that determines the target person based on the attribute acquired by way of the acquisition unit, and converts a language of an output target to a language corresponding to the target person; and
an output control unit that outputs information in the language thus converted by way of the language conversion unit.

2. An information processing device according to claim 1, wherein the output control unit outputs the information by both listing in writing according to the language thus converted by way of the language conversion unit, and writing according to a fixed language.

3. An information processing device according to claim 1, wherein the output control unit outputs the information by printing in at least one language at least including the language thus converted by way of the language conversion unit.

4. An information processing device according to claim 1, wherein the output control unit displays, on a terminal, the information in at least one language at least including the language thus converted by way of the language conversion unit.

5. An information processing device according to claim 1, further comprising a storage unit that stores an information file including a language attribute of a target person, for every position of target persons,
wherein the language conversion unit references a language attribute corresponding to the target person from the information file of the target person stored in the storage unit, and converts a language based on the language attribute thus referenced.

6. An information processing device according to claim 1, wherein the acquisition unit acquires an attribute of a target person based on clock in/out information outputted from an external device.

7. An information processing device according to claim 6, wherein the language conversion unit converts the language every time the acquisition unit acquires an attribute of a target person, based on the clock in/out information.

8. An information processing device according to claim 1, further comprising a recognition unit that recognizes, upon information being outputted, a position of a target person present at a location to output information,
wherein the output control unit outputs the information in a language set for a target person present at a position recognized by way of the recognition unit.

9. An information processing device according to claim 8, wherein the recognition unit recognizes the position of a target person by reading an identification medium of the target person present in a vicinity of a device outputting information.

10. An information processing method, comprising:
an acquisition step of acquiring an attribute of a target person accepting information;
a language conversion step of determining the target person based on the attribute acquired in the acquisition step, and converting a language of an output target to a language corresponding to the target person; and
an output control step of outputting information in the language thus converted in the language conversion step.

11. A non-transitory computer-readable medium recording a program for causing a computer to execute the following sequence of:
acquiring an attribute of a target person accepting information;
determining the target person based on the attribute thus acquired, and converting a language of an output target to a language corresponding to the target person; and
outputting information in the language thus converted.
